(19) United States
(12) Patent Application Publication
(10) Pub. No.: US 2005/0077784 A1
(43) Pub. Date: Apr. 14, 2005

(54) Vehicle track with idler and roller suspension

(76) Inventors: Piotr Dudzinski, Wroclaw (PL); Andrzej Kosiara, Wroclaw (PL); Adam Konieczny, Wroclaw (PL); Henryk Koch, Winnipeg (CA); Mirek Byczynski, Calgary (CA); William Edward Joseph Wilson, Calgary (CA)

Correspondence Address: ADE & COMPANY, 1700-360 MAIN STREET, WINNIPEG, MB, R3C3Z3, CA

(21) Appl. No.: 10/683,109

(22) Filed: Oct. 14, 2003

(51) Int. Cl. B62B 5/02

(52) U.S. Cl. 305/127; 305/128

(57) ABSTRACT

A track for a tracked vehicle has a front idler wheel carried on a frame and a front double roller member carried on the frame construction rearward of the front idler wheel. The front idler wheel and the roller member are independently pivotally mounted on the frame by pivotal levers for upward and downward suspension movement in response to change in ground level. An actuating lever extends rearwardly from the front idler wheel over the pivotal lever of the double roller and a gas bag spring is located between the actuating lever and the double roller to absorb some upward movement of the front idler wheel so as to avoid transfer of a proportional downward movement to the roller member.

This invention relates to a track for a tracked vehicle and particularly to an improved suspension arrangement for the leading idler wheel and front roller member.

### BACKGROUND OF THE INVENTION

Track vehicles generally include a pair of tracks on each side where the track includes a belt for rolling over the ground, a rear driving wheel around which the belt is wrapped for driving the belt and the front idler wheel around which the belt is wrapped so that the belt is tensioned between the front and rear wheels. It is common to provide a telescoping frame arrangement supporting the front idler wheel relative to the rear wheel so that the extension of the telescoping system acts to tension the belt. Between the front and rear wheels is mounted a plurality of rollers which are supported on the frame and extend downwardly into engagement with the bottom run of the belt so as to support the belt relative to the ground. In many cases such rollers are mounted in pairs on a walking beam arrangement allowing pivotal movement of the pair about a horizontal axis in between the pair of rollers.

In many cases, generally used for slower speed systems over smoother terrain, the wheels and rollers are mounted rigidly relative to the frame so that there is no suspension movement apart from the flexing of the belt. However higher speed and higher variations in terrain generally require that the front idler wheel and the rollers are mounted for suspension movement relative to the frame and typically theses elements may be mounted on pivot arms with suitable resilient compression springs for resisting the upward movement of the element relative to the ground. Gas bag springs are commonly used for supporting the pivot arms. Many different configurations of rollers and supports for the rollers are known.

In U.S. Pat. No. 3,774,708 of Purcell assigned to Caterpillar Tractor and issued in November 1973 is disclosed a track of this general type but in the embodiment shown both the leading and trailing wheels are idler wheels and the belt is driven in the so called “DELTA” configuration by a drive wheel which is located above the rear idler wheel so that the belt is shaped into a generally triangular arrangement wrapped around the front and rear idler wheels and over the drive wheel.

In this patent the front idler wheel is mounted on a rocker rotatably mounted to the frame of the track. On the same rocker is mounted the first undercarriage bogey or roller member carrying a pair of rollers or bogey wheels in a conventional oscillating or walking beam arrangement.

The rest of the bogey wheels are provided as oscillating bogies and are mounted on rockers at spaced positions between the first pivoting roller member and the rear idler wheel. The connection by a rocker between the idler wheel and the first bogey, where the rocker is pivotally mounted about a horizontal transverse axis on the frame, allows upward movement of the front idler wheel to be transferred as corresponding proportional downward movement of the first bogey and vice versa.

One significant disadvantage of this arrangement is that large dynamic loads on the idler wheel, generated by engagement with the ground, are transferred directly to the first pair of bogeys. The present inventors have found that this arrangement is significantly disadvantageous in that this proportional downward movement of the first bogey increases the local pressure of the belt or rubber track on the ground and significantly increases the oscillation of the whole track and therefore the machine. This oscillation significantly applies undesirable vibration to the whole machine interfering with operator comfort and interfering with the traction efficiency of the track.

### SUMMARY OF THE INVENTION

It is one object of the present invention to provide an improved suspension for a vehicle track of this general type.

According to a first aspect of the invention there is provided a track for a tracked vehicle comprising:
a frame construction for supporting the vehicle relative to the track;
an endless rotatable belt for rolling over the ground;
a drive wheel connected to a source of drive power engaging and driving the belt;
a front idler wheel carried on the frame construction and arranged to engage the belt and support the frame construction relative to the belt;
a roller member carried on the frame construction rearward of the front idler wheel and arranged to engage the belt and support the frame construction relative to the belt;
the front idler wheel being mounted on the frame construction for upward and downward suspension movement in response to change in ground level;
the roller member being mounted on the frame construction for upward and downward suspension movement in response to change in ground level;
and a linkage connected between the front idler wheel and the roller member for transferring upward movement of the front idler wheel from the ground into downward force on the roller member tending to move the roller member downwardly toward the ground and vice versa;
wherein the linkage includes a resilient spring actuable to absorb some upward movement of the front idler wheel so as to avoid transfer of a proportional downward movement of the roller member.

The type of vehicle with which the present invention is concerned can vary widely from low speed earth working vehicles to higher speed mildly vehicles. However the present invention is particularly but not essentially concerned with vehicles for arctic conditions where there can be significant rock outgrowths and intervening snow cover where it is desirable to prevent the track from digging into the snow.

The term “belt” used herein is not intended to be limited to any particular construction or material from which the belt is formed. Thus the belt can be a rubber continuous belt or can be formed of segmented metal plates, depending upon requirements. However the suspension is primarily designed for rubber belts more suitable for arctic conditions.

Preferably the resilient spring comprises a gas bag which is compressed to absorb the movement of the front idler wheel, since such gas bag springs are convenient, resistant to damage and adjustable. However other types of springs can also be used.

Preferably the front idler wheel is mounted on the frame construction for pivotal movement about a horizontal axis transverse to the length of the belt.

In this arrangement the front idler wheel is preferably mounted on a mounting lever which extends substantially forwardly from the frame construction such that the front idler wheel is mounted substantially directly in front of the pivot axis for the upward and downward movement.

Preferably the linkage includes an actuating lever extending from the pivot axis generally opposite to the mounting lever with the resilient spring or gas bag spring at the end of the actuating lever and compressible relative to the roller member. In this way the gas bag spring provides resilient suspension for both the wheel and the roller member.

Preferably the roller member is mounted on a mounting lever which extends substantially rearwardly from a pivot axis on the frame construction and the pivot axis of the front idler wheel is above the pivot axis of the roller member with the resilient gas bag spring located between the rear end of the actuating lever and the mounting lever of the roller member.

Preferably the roller member includes a pair of rollers mounted on a common walking beam pivotally carried on a central support where the gas bag is located between the actuating lever and the central support of the walking beam.

Preferably the drive wheel comprises a rear wheel of the belt and the belt extends substantially straight between the drive wheel at the rear and the front idler wheel in the standard or flat configuration rather than the so-called Delta configuration.

Preferably the frame construction includes a telescoping tensioning section for moving the front idler wheel and the roller member forwardly relative to a rear frame section carrying the drive wheel.

Thus the arrangement defined above provides an oscillating rocker lever for the front idler wheel which is connected through a spring acting as an elastic and damping element to the rocker lever of the first set of bogey wheels. The first set of bogey wheels and the idler wheel can be mounted on the front end of a telescoping tensioning system.

A similar symmetrical arrangement can be provided, for reverse movement of the vehicle, also at rear idler wheel in front of the drive wheel which is mounted on a pivotal rocker arm which is also connected by a gas bag spring to the pivotal rocker arm of the rearwardmost set of bogey wheels or rollers.

Thus the oscillating rocker arm of the front idler wheel and its connection through a resilient spring to the front set of bogeys avoids the generation of large harmful dynamic loads on the idler wheel from interaction of the undercarriage with the ground. High energy and high forces applied to the front idler wheel due to significant changes in ground height are absorbed by the spring system so that excess energy is absorbed into the gas bag spring to reduce the energy transferred to the pivot lever or rocker arm of the front set of bogies.

Tests made according to the present invention show a significant increase in the operators comfort and a significant decrease in the ground pressure applied by the belt at the location of the first set of bogies to minimize the dynamic loads of the undercarriage elements and local pressure of the track.

A further advantage of this arrangement is that a proper adjusting of the elastic and dampening element provided by the gas bag is possible to get better stability of the machine and better maneuverability.

It will be appreciated that the application of excess loads to the track and therefore to the ground by the downward movement of the first set of bogeys is significantly reduced thus decreasing the tendency of this part of the track to dig downwardly into the ground and particularly into soft snow.

Thus the present invention reduces the tendency of the track to become buried in snow by aggressive downward forces in the event that the leading idler wheel is forced upwardly by engagement with a projecting rock or other aggressive changes in ground height.

In addition the reduced tendency of the track to oscillate vertically also acts to reduce the tendency for side to side oscillation of the vehicle due to changes in forward traction on one side or other of the vehicle. Thus the vehicle tends to travel in a straighter line than normally occurs where the traction of one or other of the tracks varies significantly due to its temporary increase in engagement force with the ground.

### BRIEF DESCRIPTION OF THE DRAWINGS

One embodiment of the invention will now be described in conjunction with the accompanying drawings in which:

FIG. 1 is a side elevational view of a track according to the present nvention.

FIG. 2 is a top plan view of the track of FIG. 1.

### DETAILED DESCRIPTION

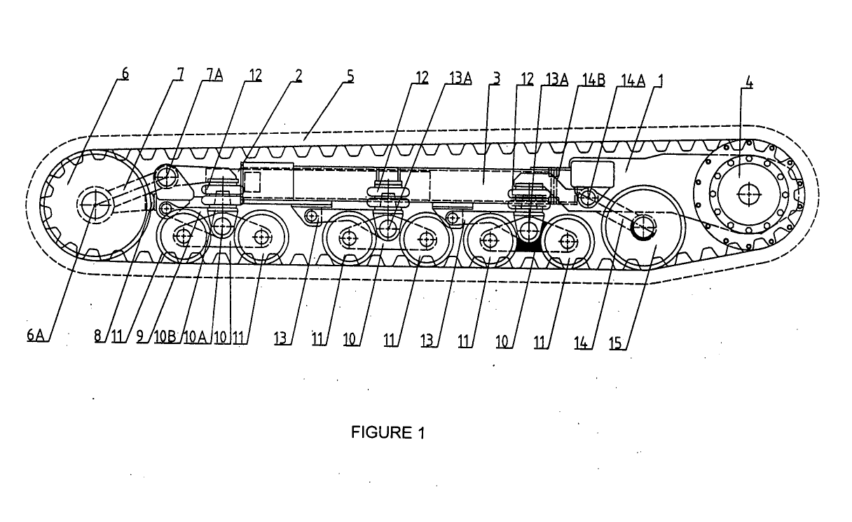

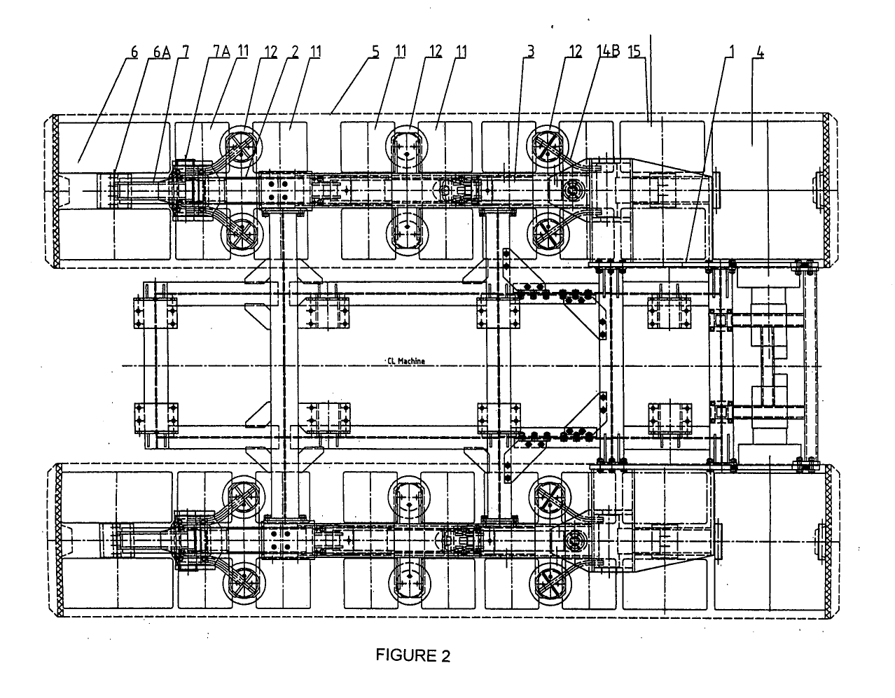

A single track of a vehicle is shown in FIGS. 1 and 2 and includes a frame construction 1 of the track which is attached to the main body of the vehicle so as to support the vehicle relative to the track. The frame construction includes a fixed rear section 1 and a movable front section 2 which can be extended forwardly by the action of a hydraulic cylinder 3 mounted inside the fixed rear section 1. Thus a tensioning effect can be obtained by applying hydraulic fluid to the cylinder 3 tending to push the forward end of the frame structure forwardly relative to the rear end. A belt 5 is wrapped around a rear driving wheel 4 carried on the rear frame section 1 and also around a front idler wheel 6 carried on the movable front section of the frame 2. Thus it will be appreciated that the belt is tensioned between the front idler wheel and the rear drive wheel and is drive by the rear drive wheel engaging the suitable projecting members on the inside of the track.

The front or leading idler wheel 6 is mounted on a rocker arm 7 pivotally mounted on the frame section 2 at a transverse pivot shaft 7A. From the shaft 7A, the arm 7 extends forwardly and slightly downwardly so that the axle 6A of the front idler wheel 6 is located just below the pivot shaft 7A of the lever or rocker arm 7. The rocker arm 7 carries an abutment 8 which engages an abutment member 8A on the front of frame section 2 so as to prevent downward movement of the arm 7 and therefore of the front wheel 6 beyond the predetermined angle. Thus normally the tensioning in the belt caused by the forward movement of the front section 2 of the frame forces the arm 7 in a counter clockwise direction into engagement with the abutment 8A. However upward forces on the front wheel 6 caused by changes in ground height cause the axle 6A to move upwardly thus rotating the rocker arm 7 in a clockwise direction around the shaft 7A. Suitable elastomeric elements can be provided at the abutment 8A so as to reduce impact forces when the front roller 6 moves downwardly as the upward forces on the belt and the roller are removed due to changes in ground height. The frame also carries a plurality of bogey wheels 11 arranged in pairs so that there are three pairs arranged one behind the other behind the leading idler wheel.

A second or rear idler wheel 15 is mounted in front of the drive wheel 4 and provides a rear point of engagement of the tract with the ground, the drive roller for being mounted in conventional manner to raise height. The rear idler wheel 15 is mounted on a rocker arm 14 symmetrical relative to the rocker arm 7 of the front idler wheel and carried on a symmetrical pivot shaft 14A.

Each of the pairs of bogies is carried on a walking beam 10 pivotally mounted on a shaft 10A so that one of the rollers 11 is mounted in front of the pivot shaft 10A and one is mounted behind. Thus each of the pairs allows upward and downward pivotal movement of the pair in opposite directions about the pivot shaft 10A in a conventional walking beam arrangement. The pivot shaft 10A carries a central support 10B through which downward force on the pair of bogies can be applied from the frame. Thus loading from the frame is transferred to the central support of each pair of bogies without loading being shared between the two bogies of the pair depending upon ground height.

Each of the center support members 10B of the bogies includes a top plate on which is mounted an elastic spring member in the form of a gas bag spring. The gas bag spring thus acts as dampening device and also as a resilient spring so as to absorb forces tending to compress the spring.

In respect of the front pair of bogies, the upper end of the gas bag spring 12 is mounted on a support plate of a lever 7B which forms a rear extension of the rocker arm 7. Thus the rocker arm 7 and the actuating lever 7B form a common element pivotally mounted on the frame at the shaft 7A so that upward movement of the axle 6A of the wheel 6 causes downward movement of the actuating lever 7B on the top of the gas bag spring 12.

Thus there is a coupling acting to transfer upward movement of the front idler wheel 6 into downward forces on the center support 10B of the first set of bogies thus tending to force the first set of bogies downwardly as the front wheel rises. However some of the energy from the upward movement is absorbed by compression of the spring 12 and the rebound energy from the compression is also dampened by the action of the gas bag spring. The front wheel 6 and the first set of bogies therefore acts as a common suspension member pivotal relative to the frame at the shaft 7A with each being able to pivot upwardly and downwardly about the shaft 7A and the transfer of forces to the other. However the presence of the gas bag spring prevents a vigorous upward movement of the front wheel 6 from being transferred into vigorous downward movement of the front set of bogies in a directly proportional movement which could otherwise cause rapid downward movement of that section of the belt causing it to engage or bury into the ground.

The rear idler wheel 15 and its rocker 14 is arranged symmetrically relative to the front idler wheel so that the rear rocker 14 includes an actuating lever 14B engaging the top of the gas bag spring 12 of the rear set of bogies.

The intermediate set of bogies includes a similar gas bag spring which is engaged directly onto the frame at the fixed section 1.

Each set of bogies includes a mounting lever 13 which extends from the shaft 10A forwardly to a pivot shaft 13A on the relevant section of the frame.

In respect of the front wheel 6 and the front set of bogies, the pivot shaft 13A of the front pivot lever 13 of the front set of bogies is located substantially directly below the pivot shaft 7A of the rocker 7 so that both are commonly carried on the front section 2 of the frame and can be moved forwardly by the action of the cylinder 3. The levers 13 thus act as a trailing link carrying the center support 10B for upward and downward movement there of on the pivoting link 13.

The front wheel 6 has a larger diameter substantially equal to the diameter of the drive wheel 4 thus supporting the upper run of track above the frame and above the bogeys. The bogies are a relatively small diameter so they are positioned underneath the frame and the bottom run of the track. The trailing or rear idler wheel 15 has a larger diameter than the bogies 11 and is positioned behind the hydraulic cylinder 13 at the rear part of the frame 1. The large diameter of the rear idler wheel 15 ensures and optimum of the bending arc of the rubber track 5 at its trailing point of engagement with the ground as it extends upwardly and rearwardly to the drive wheel 4. It will be noted from the plan view of FIG. 2 that each of the elements is arranged in pairs either side of a central support so that the idler wheel 6 is defined by two wheel components one on each side of the frame including the cylinder 3. Similarly each of the rollers 11 and the and the rear idler 15 are formed of pairs of elements. Also the gas bags 12 are arranged as pairs one on each side of the frame so as to balance the structure side to side relative to the frame.

Since various modifications can be made in our invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A track for a tracked vehicle comprising:
a frame construction for supporting the vehicle relative to the track;
an endless rotatable belt for rolling over the ground;
a drive wheel connected to a source of drive power engaging and driving the belt;
a front idler wheel carried on the frame construction and arranged to engage the belt and support the frame construction relative to the belt;
a roller member carried on the frame construction rearward of the front idler wheel and arranged to engage the belt and support the frame construction relative to the belt;
the front idler wheel being mounted on the frame construction for upward and downward suspension movement in response to change in ground level;
the roller member being mounted on the frame construction for upward and downward suspension movement in response to change in ground level;
and a linkage connected between the front idler wheel and the roller member for transferring upward movement of the front idler wheel from the ground into downward force on the roller member tending to move the roller member downwardly toward the ground and vice versa;
wherein the linkage includes a resilient spring actuable to absorb some upward movement of the front idler wheel so as to avoid transfer of a proportional downward movement of the roller member.

2. The track according to claim 1 wherein the resilient spring comprises a gas bag which is compressed to absorb the movement of the front idler wheel.

3. The track according to claim 1 wherein the front idler wheel is mounted on the frame construction for pivotal movement about a horizontal axis transverse to the length of the belt.

4. The track according to claim 3 wherein the front idler wheel is mounted on a mounting lever which extends substantially forwardly from the frame construction such that the front idler wheel is mounted substantially directly in front of the pivot axis for the upward and downward movement.

5. The track according to claim 4 wherein the linkage includes an actuating lever extending from the pivot axis generally opposite to the mounting lever with the resilient spring at the end of the actuating lever.

6. The track according to claim 1 wherein the roller member is mounted on a mounting lever which extends substantially rearwardly from a pivot axis on the frame construction.

7. The track according to claim 4 wherein the roller member is mounted on a mounting lever which extends substantially rearwardly from a pivot axis on the frame construction and wherein the pivot axis of the front idler wheel is above the pivot axis of the roller member.

8. The track according to claim 5 wherein the roller member is mounted on a mounting lever which extends substantially rearwardly from a pivot axis on the frame construction, wherein the pivot axis of the front idler wheel is above the pivot axis of the roller member and wherein the resilient spring is a gas bag located between the rear end of the actuating lever and the mounting lever of the roller member.

9. The track according to claim 1 wherein the roller member includes a pair of rollers mounted on a common walking beam pivotally carried on a central support.

10. The track according to claim 8 wherein the roller member includes a pair of rollers mounted on a common walking beam pivotally carried on a central support and wherein the gas bag is located between the actuating lever and the central support of the walking beam.

11. The track according to claim 1 wherein the drive wheel comprises a rear wheel of the belt and the belt extends substantially straight between the drive wheel at the rear and the front idler wheel.

12. The track according to claim 1 wherein the frame construction includes a telescoping tensioning section for moving the front idler wheel and the front roller member forwardly.

13. The track according to claim 11 wherein the frame construction includes a telescoping tensioning section for moving a front frame section carrying the front idler wheel and the front roller member forwardly relative to a rear frame section carrying the drive wheel.
